(19) United States
(12) Patent Application Publication
(10) Pub. No.: US 2021/0179161 A1
(43) Pub. Date: Jun. 17, 2021

(54) ELECTRICALLY ADJUSTABLE STEERING COLUMN

(71) Applicant: Robert Bosch Automotive Steering Vendôme, Vendome (FR)

(72) Inventors: David CAPELA, BUSLOUP (FR); Raphael CANON, EPIEDS EN BEAUCE (FR); Eddy DUPONT, CLOYE SUR LE LOIR (FR); Vincent EYMERY, LANCE (FR)

(21) Appl. No.: 17/113,712

(22) Filed: Dec. 7, 2020

(30) Foreign Application Priority Data
Dec. 17, 2019 (FR) 1914683

(51) Int. Cl. B62D 1/181; B62D 1/187

(52) U.S. Cl. CPC B62D 1/181; B62D 1/187

(57) ABSTRACT

A steering column including a support base configured to be fixedly mounted with respect to a vehicle chassis, a steering member configured to be connected to a vehicle steering wheel, said steering member being pivotally mounted with respect to said support base about a first transverse axis, a steering column tilt adjustment device for tilt adjustment of the steering member with respect to the support base by pivoting the steering member about the first transverse axis, where the steering member tilt adjustment device includes an actuator which is mounted on the steering member so as to pivot about a second transverse axis substantially parallel to the first transverse axis.

### CROSS REFERENCE TO RELATED APPLICATION

This application is related to and claims the benefit of French Patent Application Number 1914683 filed on Dec. 17, 2019, the entire contents of which are incorporated herein by reference.

### TECHNICAL FIELD

The present disclosure relates to an electrically adjustable vehicle steering column, more particularly a steering column adjustable in height relative to a support base fixed to the vehicle chassis.

### BACKGROUND

The steering column according to the disclosure is intended in particular but not exclusively for a motor vehicle.

Steering columns transmit the rotation of the steering wheel to the wheels to change their orientation, for example in the following order: steering wheel, steering column, intermediate axle, rack and pinion and finally the wheels.

Related art steering columns allow the steering wheel to be adjusted in depth and/or height.

A related art steering column includes:
a steering member intended to be connected to a vehicle steering wheel,
a support base supporting this member in relation to the vehicle chassis,
adjustment means arranged to be able to change the height of the steering member in relation to this support base.

If you want to be able to adjust the tilt of the steering element electrically, it is known to use mechanisms using various levers to change the tilt of the steering element with the help of an electric actuator. Existing systems are relatively complex since they require a large number of components such as cantilever systems, columns, racks . . . .

The multiplication of connections and components within the steering column has an impact on the kinematics and the assembly process. In addition, when adjusting the height of a steering column via a cantilever, for example, there is a direct impact on the lower pivot. It is then necessary to add a degree of freedom on the lower pivot to avoid problems of hyperstatism.

### BRIEF SUMMARY

A purpose of the present disclosure is to respond to the disadvantages of the above-mentioned prior art, in particular by reducing the number of connections necessary to allow height adjustment. The disclosure aims at proposing a less expensive solution in terms of parts but also in terms of assembly process.

For this purpose, a first aspect of the disclosure concerns a steering column comprising a support base intended to be fixedly mounted with respect to a vehicle chassis, a steering member intended to be connected to a vehicle steering wheel, said steering member being pivotally mounted with respect to said support base about a first transverse axis, a steering member tilt adjustment device for tilt adjustment with respect to the support base by pivoting the steering member about the first transverse axis. The steering column is characterized in that the steering member tilt adjustment device comprises an actuator which is pivotally mounted on the steering member about a second transverse axis substantially parallel to the first transverse axis. The actuator controls the translation of an actuating member which is articulated on the support base about a third transverse axis substantially parallel to the first transverse axis.

Thus the disclosure reduces costs by reducing the number of components, simplifying kinematics, and facilitating assembly. In particular, the disclosure allows lateral assembly of the entire steering member tilt adjustment device, without complex manipulations, since it is possible to mount the adjustment device on only one side of the steering column. The disclosure also makes it possible to reduce the mass of the steering column and the external dimensions.

According to an alternative embodiment of the disclosure, the translation direction of the actuator is substantially perpendicular to the second transverse axis.

According to an alternative embodiment of the disclosure, the actuating element is an adjusting screw.

According to an alternative embodiment of the disclosure, the adjusting screw is pivotally mounted on the support base and is movable in translation with respect to the actuator.

In an alternative embodiment of the disclosure, the adjusting screw is screwed into a nut which is pivotally mounted on the support base, the adjusting screw being fixed in relation to the actuator.

According to an alternative embodiment of the disclosure, the actuator is a geared motor.

According to an alternative embodiment of the disclosure, the part of the steering member which is directly mounted on the support base is called the lower body, and the lower body has a transverse second pivot pin which is provided for the pivot mounting of the actuator about the second transverse axis.

According to an alternative embodiment of the disclosure, the second pivot pin is made in one piece with the lower body or with the actuator body.

According to an alternative embodiment of the disclosure, the second pivot pin is a separate part which is mounted in a bearing on the lower body and in a bearing on the actuator body.

According to an alternative embodiment of the disclosure, the support base comprises two longitudinal members, which extend generally parallel to the steering member, and a transverse shaft which is attached to the two longitudinal members, one of the free ends of the transverse shaft forming a pivot for the articulation of the actuating member on the support base about the third pivot axis.

### BRIEF DESCRIPTION OF THE DRAWINGS

Other characteristics and advantages of the present disclosure will appear more clearly on reading the following detailed description of an embodiment of the disclosure given as an example, which is by no means restrictive and illustrated by the appended drawings, in which:

FIG. 1] is a perspective view which represents an example of a steering column according to a first embodiment of the disclosure;

FIG. 2] is a cross-section view according to Plane 2-2, which represents the steering column of FIG. 1;

FIG. 3] is a side view which represents the steering column of FIG. 1 in a first tilted position;

FIG. 4] is a side view which represents the steering column of FIG. 1 in a second tilted position;

FIG. 5] is a side view similar to that of FIG. 3 representing a second embodiment of the disclosure;

FIG. 6] is a view similar to the one of FIG. 2 which represents an alternative embodiment of the pivot connection between the actuator and the lower body of the steering column of FIG. 1 in which a second pivot pin is arranged on the side of the actuator;

FIG. 7] is a view similar to the one of FIG. 2, which represents an alternative embodiment of the pivot connection between the actuator and the lower body of the steering column of FIG. 1 in which the second pivot pin is separated from the actuator body and the lower body.

### DETAILED DESCRIPTION

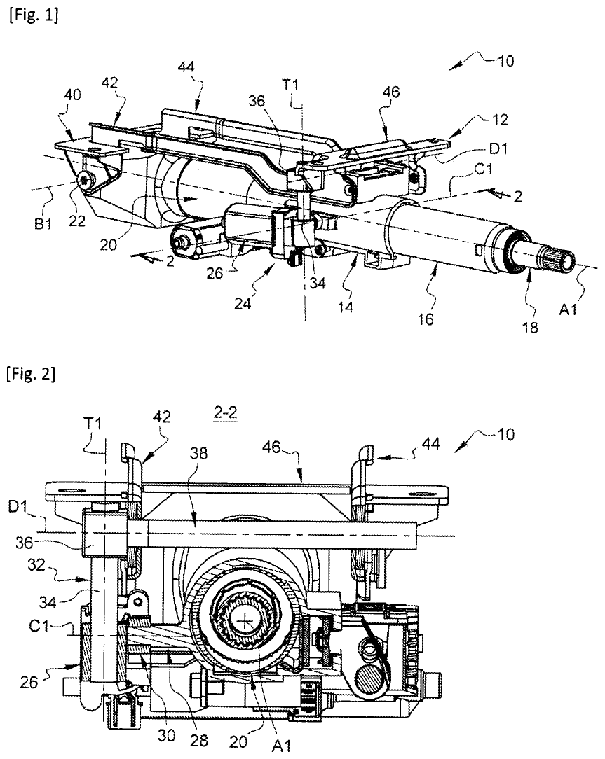

FIGS. 1 to 4 illustrate a steering column 10 for a motor vehicle according to a first embodiment of the disclosure, integrating a support base 12, also called a cap, for a steering member 14. This support base 12 is intended to be fixed to the chassis of the vehicle (not shown), during the assembly of the latter.

The steering member 14 comprises a tube, known as the upper tube 16, connected to a steering wheel nipple 18, the latter being intended to be connected to the steering wheel (not shown) of the vehicle. The steering wheel nipple 18 forms the end of a steering shaft that is free to rotate about an axis of rotation. This rotation transmits the steering wheel rotations to the steering mechanisms (not shown) that cause the vehicle's wheels to steer. This axis of rotation is called the steering column axis A1.

The upper tube 16 is slidably mounted in a lower body 20 according to an axial adjustment axis, coaxial with the steering column axis A1. This sliding allows a depth adjustment of the steering wheel, also called axial adjustment.

The lower body 20, is mounted freely rotating around a first pivot pin 22, or pivot shaft, carried by the cap 12. This is an example of a design allowing the articulation of the steering member 14 to the support base 12 by pivoting around a first pivot axis B1. This swivel allows radial adjustment of the steering wheel about the first pivot axis B1. The first pivot pin 22 is intended to be horizontal when the steering column 10 is mounted in the vehicle. This radial adjustment is also referred to as height adjustment or tilt adjustment.

In the following part of the description, the term transverse will be used, without limitation, to describe a direction that is substantially parallel to the first pivot axis B1.

The steering column 10 also has a steering member tilt adjustment device 24. This steering member tilt adjustment device 24 comprises an electric actuator 26 which is pivotally mounted on the steering member 14 about a second transverse pivot axis C1 which is substantially parallel to the first pivot axis B1. According to the design shown, the lower body 20 is provided with a second pivot pin 28, or pivot shaft, which is fixed in relation to the lower body 20 and which extends on a side flank of the lower body 20, on the left as seen in FIG. 2, to allow pivotal mounting of the actuator 26. The second pivot pin 28 is here made in one piece with the lower body 20 and the actuator 26 has a bearing 30 designed to pivotally receive the free end of the second pivot pin 28.

According to an alternative embodiment shown in FIG. 6, the second pivot pin 28 can be arranged directly on the actuator 26, e.g. it can be made in one piece with the body of the actuator 26, and the bearing 30 can be arranged on the lower body 20. For the other parts, the structure of the steering column 10 and the steering member tilt adjustment device 24 remain the same.

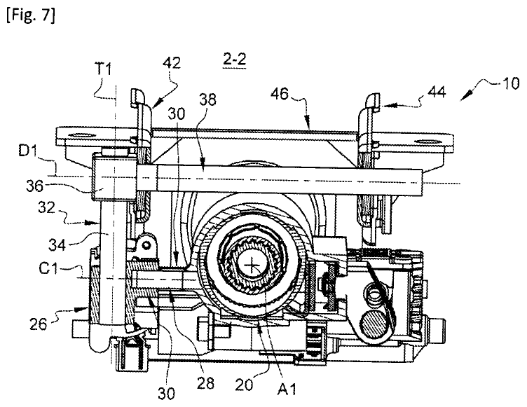

According to another alternative embodiment shown in FIG. 7, the second pivot pin 28 is designed as a separate cylindrical part which is pressed into a bearing 30 formed on the body of the actuator 26 and into a bearing 30 formed on the lower body 20 in order to provide the pivot connection between the actuator 26 and the lower body 20. For the other parts, the structure of the steering column 10 and the steering member tilt adjustment device 24 remain the same.

The steering member tilt adjustment device 24 furthermore comprises an actuating member 32 which is controlled by the actuator 26 and which is articulated on the support base 12 about a third transverse pivot axis D1 so as to change the tilt of the steering member 14 relative to the support base 12 by means of a translational movement of the actuating member 32. Thus, in addition to the first pivot pin 22, the steering member 14 is connected to the support base 12 by two pivot connections, one arranged between the actuator body 26 and the lower body 20, the other arranged between the actuator member 32 and the support base 12.

Preferably the actuator 26 is a worm and gear motor gearbox which is designed to rotate an adjusting screw 34.

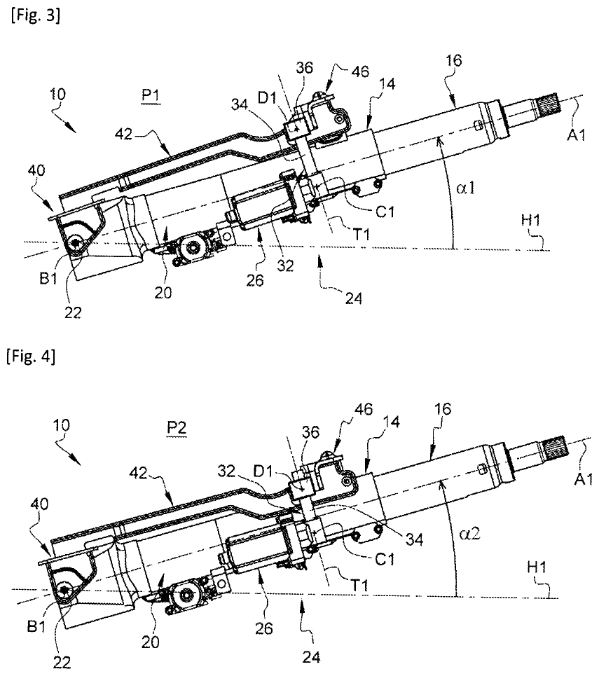

According to the first embodiment shown in FIGS. 1 to 4, the actuator member 32 comprises the adjusting screw 34 and the nut 36. The adjusting screw 34 is here intended to be rotated by the actuator 26 so that it rotates on itself about its axis, which corresponds to the translation direction T1. The adjusting screw 34 is here of the fixed type, i.e. it is locked in translation relative to the actuator 26. The adjusting screw 34 cooperates with the nut 36 in such a way that it moves in the translation direction T1, through the nut 36, relative to the support base 12. This displacement is illustrated in FIGS. 3 and 4, which show the steering member 14 in two distinct tilted positions P1, P2, one at a first angle α1 and the other at a second angle α2 with respect to a horizontal plane H1. Nut 36 is here pivotally mounted around a transverse shaft 38 which is fixed on the support base 12.

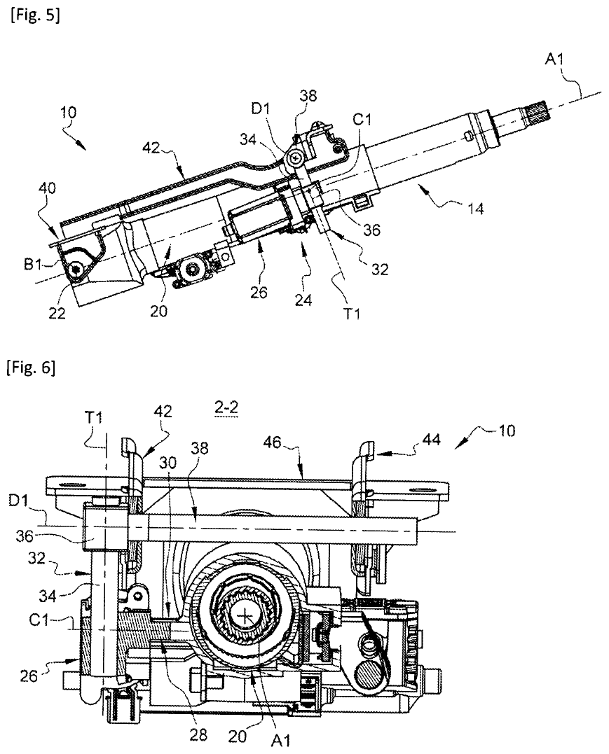

The second embodiment, which is shown in FIG. 5, differs from the first embodiment in that the adjusting screw 34 is of the movable type, i.e. it is movable in translation, along the translation direction T1, with respect to the actuator 26. The nut 36 here comprises a threaded element driven in rotation by the actuator 26 in such a way as to cause a displacement of the adjusting screw 34 with respect to the actuator 26. One end of the adjusting screw 34 is here provided with a bearing which is hinged to a free end of the transverse shaft 38 so that the adjusting screw 34 can be pivoted about the third pivot axis D1.

According to the embodiments shown, the support base 12 comprises a lower plate 40 which supports the first pivot pin 22, two longitudinal members 42, 44 which extend generally parallel to the steering member 14 from the lower plate 40 to an upper plate 46. The transverse shaft 38 is attached to the upper end of each longitudinal member 42, 44 which, together with the upper plate 46, helps to stiffen the entire support base 12.

Preferably, the nut 36, according to the first embodiment, or the adjusting screw 34, according to the second design, is hinged against a side wall of one longitudinal member 42, on the opposite side to the other longitudinal member 44.

The operation of the steering member tilt adjustment device 24 is now described according to the disclosure, in particular with reference to FIGS. 3 and 4 of the first embodiment.

Starting from the first tilted position P1 shown in FIG. 3, the geared motor is controlled in a first direction of rotation which causes a corresponding rotation of the adjusting screw 34. By turning on itself, the adjusting screw 34 cooperates with the threads of the nut 36 which generates a translation of the adjusting screw 34 through the nut 36, here upwards, until the geared motor stops. By moving upwards, the adjusting screw 34 causes the actuator 26 to move upwards, which in turn causes the steering member 14 to move upwards as well, since the actuator 26 and the steering member 14 are connected by the second pivot pin 28 and the bearing 30. Thus, after the geared motor has stopped, the steering member 14 occupies the second tilted position P2 shown in FIG. 4. Of course, by controlling the geared motor in the opposite direction, it is possible to control the pivoting of the steering member 14 in the opposite direction, in this case downwards.

It will be understood that various modifications and/or improvements obvious to the person skilled in the art may be made to the different embodiment of the disclosure described in the present description without going beyond the scope of the disclosure defined by the appended claims.

For example, according to an alternative embodiment (not shown), the position of actuator 26 and the position of actuator 32 could be reversed. That is, the actuator 26 could be pivotally mounted on the support base 12 and the actuator 32 could be pivotally mounted on the steering member 14.

1. Steering column, comprising:
a support base configured to be fixedly mounted with respect to a vehicle chassis,
a steering member configured to be connected to a vehicle steering wheel, said steering member being pivotally mounted with respect to said support base about a first transverse axis,
a steering column tilt adjustment device for tilt adjustment with respect to the support base by pivoting the steering member about the first transverse axis,
wherein the steering column tilt adjustment device comprises an actuator which is mounted on the steering member, or on the support base, so as to be pivotable about a second transverse axis substantially parallel to the first transverse axis, in that the electric actuator controls the translation of an actuating member along a translation direction, and in that the actuating member is articulated on the support base, respectively on the steering member, about a third transverse axis substantially parallel to the first transverse axis,
in that the part of the steering member which is directly mounted on the support base is called the lower body, and
wherein, in addition to a first pivot pin forming the first transverse axis, the steering member is connected to the support base by two pivot connections, one arranged between the actuator body and the lower body, the other arranged between the actuator member and the support base.

2. Steering column according to claim 1, wherein the translation direction of the actuating member is substantially perpendicular to the second transverse axis.

3. Steering column according to claim 1, wherein the actuating member comprises an adjusting screw.

4. Steering column according to claim 3, wherein the adjusting screw is pivotally mounted on the support base and is translationally movable relative to the actuator.

5. Steering column according to claim 3, wherein the adjusting screw is screwed into a nut which is pivotally mounted on the support base, the adjusting screw being fixed relative to the actuator.

6. Steering column according to claim 1, wherein the actuator is a geared motor.

7. Steering column according to claim 1, wherein the lower body has a transverse second pivot pin which is provided for the pivotal mounting of the actuator about the second transverse axis.

8. Steering column according to claim 7, wherein the second pivot pin is made in one piece with the lower body or with the actuator body.

9. Steering column according to claim 7, wherein the second pivot pin is a separate part which is mounted in a bearing on the lower body and in a bearing on the actuator body.

10. A steering column according to claim 1, wherein the support base comprises two longitudinal members, which extend generally parallel to the steering member, and a transverse shaft which is fixed to the two longitudinal members, one of the free ends of the transverse shaft forming a pivot for articulation of the actuating member on the support base about the third pivot axis.
